(19) United States
(12) Patent Application Publication
(10) Pub. No.: US 2007/0157426 A1
(43) Pub. Date: Jul. 12, 2007

(54) Door closer

(75) Inventor: Horst Tillmann, Ennepetal (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 10/586,095

(22) PCT Filed: Jan. 14, 2005
(86) PCT No.: PCT/EP05/00297

§ 371 Date: Jul. 14, 2006

(30) Foreign Application Priority Data
Jan. 21, 2004 (DE) 10 2004 003 280.7

(51) Int. Cl. E05F 3/00

(52) U.S. Cl. 16/49

(57) ABSTRACT

A door closer includes a housing for receiving a door closing mechanism. The housing includes two attaching flanges, each of the attaching flanges having three attachment holes for receiving attachment components.

The invention relates to a door closer having a housing for accommodating a closing mechanism, the housing being provided with attaching flanges, wherein attachment holes are provided for attachment components penetrating therethrough.

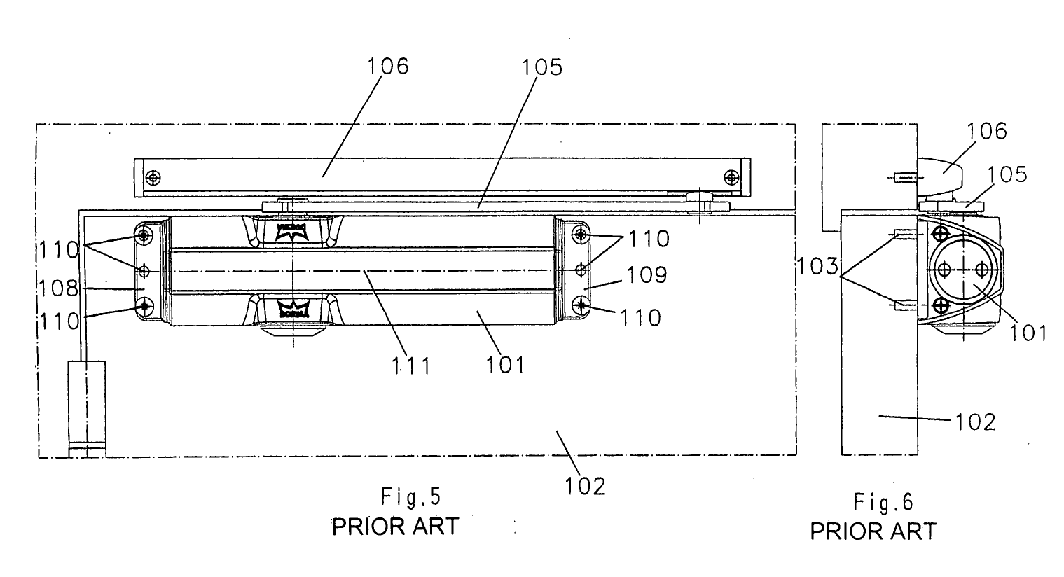

A door closer of this type is revealed in DE 198 889 A1. The door closer of the state-of-the-art will be explained based on FIGS. 5 and 6.

These door closers have a housing 101 and they are mounted for example in the upper area of a door 102 or the like. They either cooperate with a guide rail 106, which is connected via a lever 105 to the door closer or they have a generally known parallel arm assembly. For attaching the door closer at the door 102 or the like, attaching flanges 108, 109 are disposed at the housing 101 of the door closer, which have two attachment holes 110 respectively, which are penetrated by fastening screws 103. The attachment holes 110 provided at each attaching flange 108, 109 are disposed on both sides of a longitudinal centre plane 111 extending through the housing 101.

In the state-of-the-art, the two attachment holes 110 are disposed such that the upper attachment holes 110 are located about 28 mm below the upper edge of the door 102 or the like and the lower attachment holes 110 are located about 19 mm below the former (see FIG. 6). In general such an arrangement of attachment points at a door is referred to as a group of holes. On doors, whether frame doors or solid leaf doors, such a group of holes is located within a very restricted area. With solid leaf doors, the door is additionally reinforced within a certain area to allow the door closers to be screwed on. Outside this area a reasonable permanent attachment of a door closer is not possible, except when using a mounting bracket, which, however, increases the overall cost of the product. Until now, the lever 105 connecting the door closer to the guide rail 106 is provided with a cranking 112, in order to be able to reach such a group of holes. However, such a cranked lever 105 excludes a universal use of only one door closer embodiment for all door situations and thus mounting types.

Therefore, it is an object of the present invention to provide a door closer, which is universally usable, i.e. which can be employed in all mounting situations with additional components, such as for example a mounting bracket.

This problem is solved with a door closer for the above described type in that three attachment holes are disposed in each attaching flange.

The inventive embodiment provides a door closer, which is universally usable and which allows for abandoning the use of a cranked lever. If, namely for screwing the door closer to a door or the like, only the two lower holes are always used, the door closer moves further to the top, such as to terminate flush with the upper edge of the door or the like and thus using a cranked lever is redundant. Another advantage is that with profile frame doors, having a glass panel therebetween, a door closer according to the invention does not protrude into the glass, because a door closer mounted like this would seriously harm the appearance of a profile frame door.

The dependent claims represent further embodiments of the inventive subject matter.

According to an advantageous further development, it is intended that the attaching flanges are disposed at the end surfaces of the housing. This allows for reliable attachment and good power transmission.

Advantageously, the distance of the attachment holes among each other is identical. Advantageously, the distance is about 19 mm. According to another embodiment, the attachment holes are aligned below each other. On account of such an arrangement of the attachment holes, a group of holes is provided, which allows for a universal installation of the door closer.

The central attachment hole is preferably located on the longitudinal central axis of the housing. On account of this embodiment it is possible to maintain the distance of about 28 mm, for example, of the upper fastening screw from the upper edge of the door or the like, which distance is known from the state-of-the-art, and simultaneously to dispose the door closer flush with the upper edge of the door or the like. This is particularly important with rebated door leaves and tubular frame doors having a glass panel. Particularly with tubular frame doors, which are made for example from light metal, the person skilled in the art would like to reduce the frame to minimum dimensions.

According to an advantageous further development, the two exterior attachment holes are located in the area of the exterior longitudinal edges of the housing.

Further features and advantages of the inventive door closer will result from the following description of a preferred exemplary embodiment, in which:

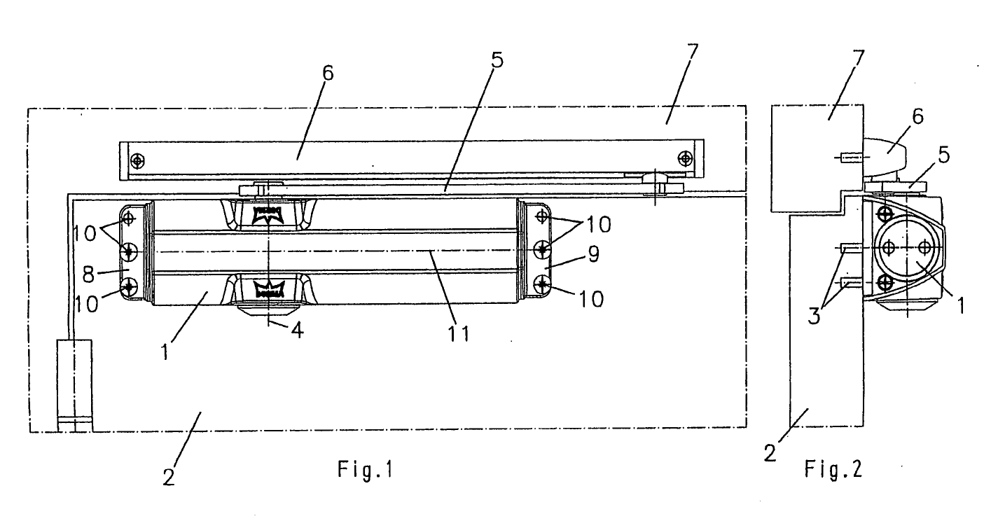

FIG. 1 shows a plan view on an inventive door closer at a rebated timber door;

FIG. 2 shows a lateral view of an inventive door closer according to FIG. 1;

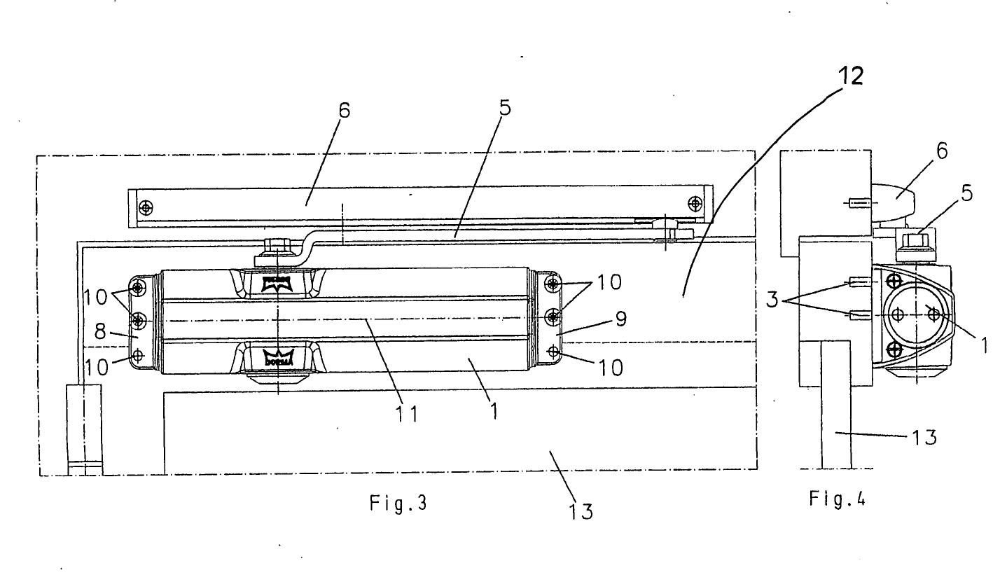

FIG. 3 shows a plan view on a door closer at a frame door;

FIG. 4 shows a lateral view according to FIG. 3;

FIG. 5 shows a plan view on a door closer according to the state-of-the-art, and

FIG. 6 shows a lateral view on a door closer according to the state-of-the-art.

The inventive door closer is illustrated in FIGS. 1 and 2 in a plan view and in a lateral view.

The door closer has a housing 1, which is attached at a door 2 or the like via fastening screws 3, which is formed for example as a timber door with a rebate. A shaft 4, at which a lever 5 is fixed engaging with the other end in a guide rail 6, extends from the housing 1 of the door closer. The guide rail 6 is attached at a wall 7 or the like.

Both end surfaces of the housing 1 are provided with respectively one attaching flange 8, 9, wherein three attachment holes 10 are provided. The attachment holes 10 serve to accommodate the fastening screws 3.

In each attaching flange 8, 9, the attachment holes 10 are equally spaced apart from each other, for example by about 19 mm. Moreover, they are aligned with each other.

The attachment holes 10 are disposed such that the central attachment hole 10 is located in a longitudinal centre plane 11 of the housing 1.

When fastening the housing 1 at a door 2 or the like, according to FIGS. 1 and 2, only the central and lower attachment holes 10 on each side of the door closer (housing 1) in the attaching flanges 8, 9 will be used, because the upper attachment hole 10 would not have enough support on account of the existing rebate in the door 2. As a result with the same attachment pattern as in the state-of-the-art, i.e. the upper fastening screw 3 still being disposed about 28 mm below the upper edge of the door 2 or the like, the housing 1 of the door closer moves about 9,5 mm to the top with the indicated distance of the attachment holes 10 of about 19 mm, and thus the housing 1 of the door closer extends flush with the upper edge of the door 2 or the like. On account of this embodiment, the cranked lever for example, required in the state-of-the-art, can be eliminated, contributing to an overall improved appearance of the door closer.

In FIGS. 3 and 4 the housing 1 of the door closer is attached at a door 2 having a frame 12. Such frame doors can be formed with or without a rebate and they carry a glass panel 13 within the frame 12. Thus, the area at which the door closer can be attached is limited by the width of the frame. As FIGS. 3 and 4 reveal, the housing is attached at the frame 12 by means of the upper two attachment holes 10 via screws.

### LIST OF REFERENCE NUMERALS

1 housing
2 door
3 fastening screws
4 shaft
5 lever
6 guide rail
7 wall/frame
8 attaching flange
9 attaching flange
10 attachment holes
11 longitudinal centre axis
12 frame
13 glass panel
101 housing
102 door
103 fastening screws
105 lever
106 guide rail
108 attaching flange
109 attaching flange
110 attachment holes
111 longitudinal centre axis
112 cranking

1-6. (canceled)

7. A door closer comprising:
a housing for receiving a door closing mechanism, the housing comprising two attaching flanges, each of the attaching flanges having three attachment holes for receiving attachment components.

8. The door closer of claim 7, wherein the housing has two end surfaces, and the attaching flanges are disposed at the end surfaces, respectively.

9. The door closer of claim 8, wherein the attachment holes of each of the attaching flanges are equally spaced from one another.

10. The door closer of claim 9, wherein the attachment holes of each of the attaching flanges are aligned with each other.

11. The door closer of claim 10, wherein the housing has a longitudinal central plane, and the central attachment hole of each of the attaching flanges is disposed in the longitudinal central plane.

12. The door closer of claim 11, wherein the remaining two attachment holes of each of the attaching flanges are offset from the longitudinal central plane.
